(19) United States
(12) Patent Application Publication
(10) Pub. No.: US 2003/0055970 A1
(43) Pub. Date: Mar. 20, 2003

(54) On-demand resource editor for dynamically generated web page documents

(76) Inventor: Iraklis Kourtidis, Palo Alto, CA (US)

Correspondence Address: MORRISON & FOERSTER LLP, 755 PAGE MILL RD, PALO ALTO, CA, 94304-1018, US

(21) Appl. No.: 09/956,511

(22) Filed: Sep. 17, 2001

(51) Int. Cl. G06F 15/173; G06F 15/16

(52) U.S. Cl. 709/226; 709/218

(57) ABSTRACT

A resource handler program executes on a server computer. The resource handler program is particularly suited for executing in conjunction with a dynamic page code generation program that generates display source code for execution on a client computer to render a document on the client computer. The resource handler program includes a resource value provider that, based on a request generated by the page code generation program for a resource value, interacts with a resource repository to return a value for the resource to be included in the display source code. A resource association provider of the resource handler program operates in conjunction with the resource value provider to generate display source code to associate a portion of the display with a location in the resource repository associated with the resource. The display source code generated by the resource association provider is such that when the display source code is executed on the client computer, the portion of the display visually indicates the resource with which the portion is associated. Furthermore, when the portion of the display is indicated by the user, activation of a resource editor is requested to provide for changing the values for the resource. As a result, for a user to initiate editing of a particular resource, the user need only activate the portion of the display associated with the resource and the resource editor is automatically entered for editing the resource without requiring the user to explicitly identify the resource.

### TECHNICAL FIELD

The present application is in the field of editing resources renderable as part of a dynamically-generated web page document and, in particular, to a method and apparatus for on-demand resource editing for dynamically generated web page documents.

### BACKGROUND

Generation of dynamic web page documents is known in the art. Referring to FIG. 1, a browser program 102 executing on a client computer issues a request 103 for a web page document and receives generated HTML 104 (typically via the internet) via hypertext transfer protocol (HTTP) from a dynamic page generator module 106 on a server computer. It should be noted that the term “server computer” is meant to include a “logical” server computer. That is, the server computer need not be one physical computer but may be, for example, a plurality of computers operating in conjunction with each other. In fact, the plurality of computers of which a server computer may be comprised need not even be at a single physical geographic location (e.g., within the same room, building, campus, etc.) The dynamic page generator module 106 processes web page source code 108 to generate the HTML 104 based in part on “resources” that describe at least some of the display elements. Typically, a resource attribute is a constant, whose value is some constant text string. In other instances, a resource attribute is an image. Other attributes include styles and even a type or subtype such that a style can apply to all resources of such a type or subtype. The browser program 102 processes the generated HTML 104 to render a document (such as what is known generally as a “web page”) on a display associated with the client computer.

The attribute values of some resources may be hard coded into the web page document source code 108, while the attribute values of other resources may be “soft” coded into the web page document source code 108 with some sort of indirect reference to the resource. For example, the indirect reference may be a function call in the web page document source code 108 that causes the dynamic page generator module 106 to generate a request 110 to a resource provider module 112 to access a resource repository 114. The resource provider module 112 accesses the resource repository 114 and provides the attribute values 116 back to the dynamic page generator module 106 to be included in the generated HTML 104.

To edit a resource (i.e., to change the attributes of the resource) in the resource repository 114, various tools are conventionally employed. A generic resource editor tool 118 is shown in FIG. 1. These tools typically fall into one of three categories.

The first category is a text editor, and the attribute (or attributes) of a resource is changed merely by editing a textual resource file that includes a definition of the resource. In this case, the text editor does not recognize the textual resource file as a resource file but, rather, only knows that the file being edited is some text file. Furthermore, a user must know the name of the resource to be edited and search for that specific name to change the attributes of the resource.

The second category includes “static” resource editors such as is included with Microsoft's Visual C++ product. While these are specialized resource editors that provide special facilities to edit resources, as with a text editor, a user must know the name of the resource to be edited and search for that specific name to change the attributes of the resource.

The third category includes what-you-see-is-what-you-get (WYSIWYG) editors, such as Netscape's Composer product and Microsoft's Frontpage Express product. With WYSIWYG editors, the user must open a particular page as a file to modify it. Notably, the user must first know the name of the page it is desired to modify. Furthermore, some web page documents are defined dynamically and, thus, cannot be edited using a WYSIWYG editor. That is, editors such as the ones mentioned operate on pure HTML pages, not generated ones. However, some files that are utilized by certain mechanisms for generating HTML (such as code written in JSP—Java Server Pages—files, or other “template systems”) may “look like” HTML files sufficiently, so that certain parts of the page may still be viewed in a WYSIWYG editor. In that case, the editor can only be used to modify those parts of the page that are not dynamically generated.

With all of these categories of resource editing just described, it is difficult for a novice user to change the attributes of a resource that is rendered on a dynamically-generated web page document. More properly, it is not the limited act of changing the attributes of the resource that is particularly difficult. What is difficult is finding what needs to be edited to change the attributes of the resource.

What is desired then, is a method and apparatus that simplifies the process of changing the attributes of web page document resources.

### SUMMARY

A resource handler program executes on a server computer. The resource handler program is particularly suited for executing in conjunction with a dynamic web page code generation program that generates display source code for execution on a client computer to render a document on the client computer. The resource handler program includes a resource value provider that, based on a request generated by the web page code generation program for a resource value, interacts with a resource repository to return a value for the resource to be included in the display source code.

A resource association provider of the resource handler program operates in conjunction with the resource value provider to generate display source code to associate a portion of the display with a location in the resource repository associated with the resource (e.g., the “location” may be an “ID” of the resource). The display source code generated by the resource association provider is such that when the display source code is executed on the client computer, the portion of the display visually indicates the resource with which the portion is associated. Furthermore, when the portion of the display is indicated by the user, activation of a resource editor is requested to provide for changing the values for the resource.

As a result, for a user to initiate editing of a particular resource, the user need only activate the portion of the display associated with the resource and the resource editor is automatically entered for editing the resource.

### BRIEF DESCRIPTION OF THE DRAWINGS

FIG. 1 illustrates a conventional architecture for dynamic web page document generation.

FIG. 2 illustrates processing in accordance with an embodiment of the invention to generate HTML for a resource.

FIG. 3 illustrates a web page document rendered in accordance with HTML generated in accordance with an embodiment of the invention, for a “non-edit mode”.

FIG. 4 illustrates the web page document of FIG. 3, rendered in accordance with HTML generated for an “edit mode”.

FIG. 5 illustrates a resource editor page rendered in response to activation of a portion of the FIG. 4 web page document.

FIG. 6 illustrates a preview page of the resource editor rendered in response to activation of a “preview” button on the FIG. 5 web page document.

### DETAILED DESCRIPTION

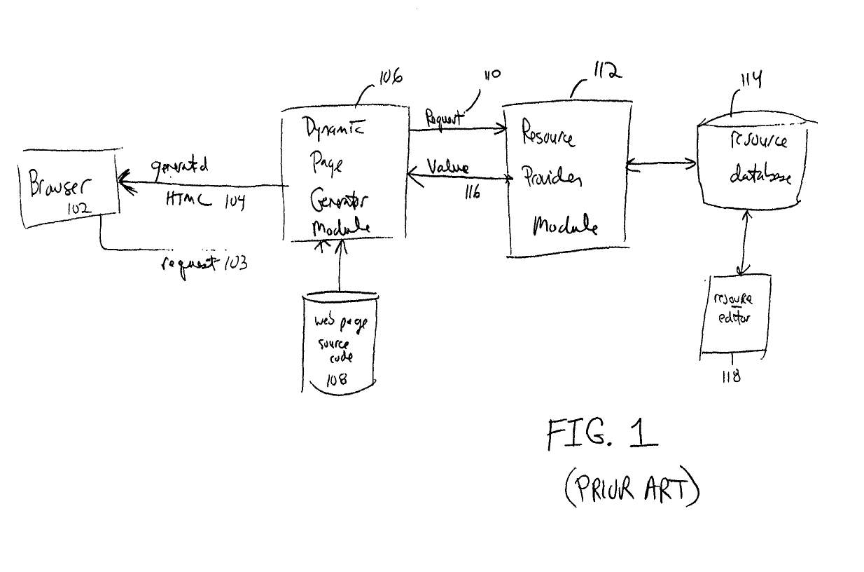

Referring still to FIG. 1 described in the Background, in accordance with an embodiment of the invention, the dynamic page generator module 106 performs processing to generate HTML 104 such that resource attribute values (for example, static text or an image) are rendered by the browser as they would appear conventionally. As is described in detail below, the user who wants to edit a resource may employ the browser 102 to navigate to a web page document on which the resource is rendered. The user can than switch to an “edit mode” (by, for example, activating an “edit” button on the display), refresh the page in the browser window, and then click on (or around) the resource to modify it.

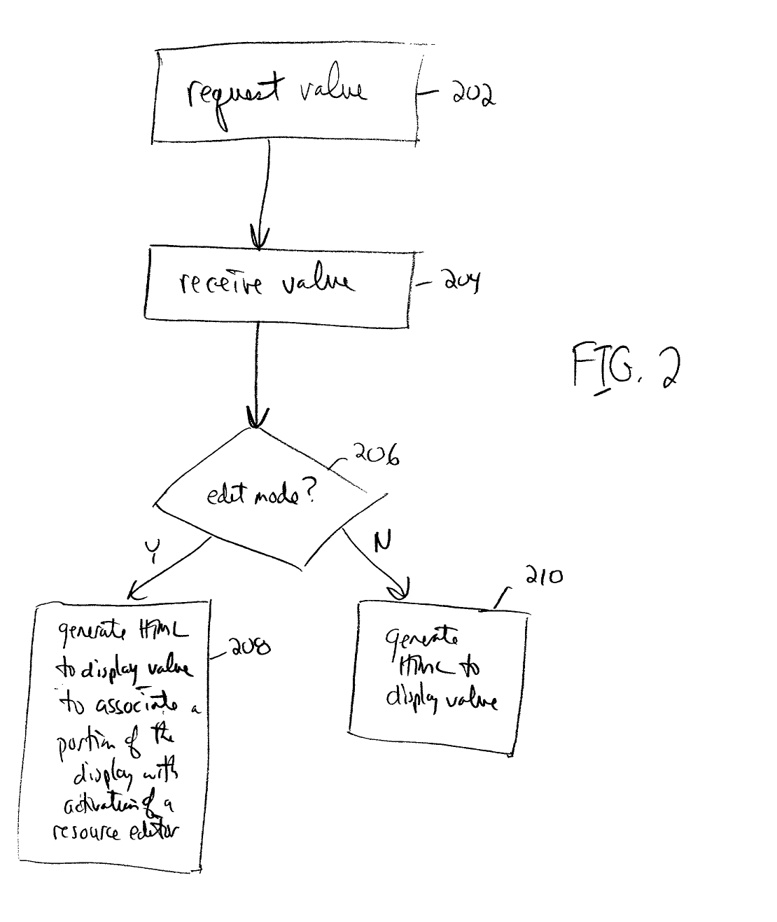

There is no need for the user to know the name of the resource, or to know the name of the page in which the resource appears. In addition, the programmer of the web page source code 108 does not need to write any extra code to account for the edit mode. In addition, the method employed is such that the generated code is browser-, operating system-, and programming language-independent, as long as the application utilizing resources renders HTML (or some other standard code that can be processed by a browser or other page rendering program). The concept of “in place” editing in accordance with an “edit mode” embodiment, as described above, is now set forth in greater detail with reference to FIGS. 2-8.

Turning first to FIG. 2, this figure is a flowchart illustrating a relevant portion of the processing within the dynamic page generator module 106 (as modified in accordance with the invention) in accordance with the “edit mode” embodiment. At step 202, the request for a resource attribute value is passed to the resource provider module 112, which retrieves the value from the resource repository 114. The resource provider module 112 passes the resource attribute value 116 back to the dynamic page generator module 106 which receives the resource attribute value 116 at step 204.

At step 206, it is determined if the HTML 104 is to be generated for “edit mode”. If it is determined at step 206 that HTML 104 is to be generated for “edit mode”, then the HTML 104 generated is such that, when rendered by the browser 102, a portion of the display is associated with a location in the resource repository associated with the resource. For example, the HTML 104 generated may include a link to a resource editor along with an identification of the resource such that the resource editor can locate the resource in the resource repository 114. When the HTML 104 is processed by the browser 102, a portion of the display visually indicates a resource with which the portion is associated. In addition, when the portion of the display is indicated by the user (e.g., by clicking on the portion or otherwise “indicating” the portion), a request is made to activate a resource editor to provide for changing the values of attributes of the resource with which the portion is associated.

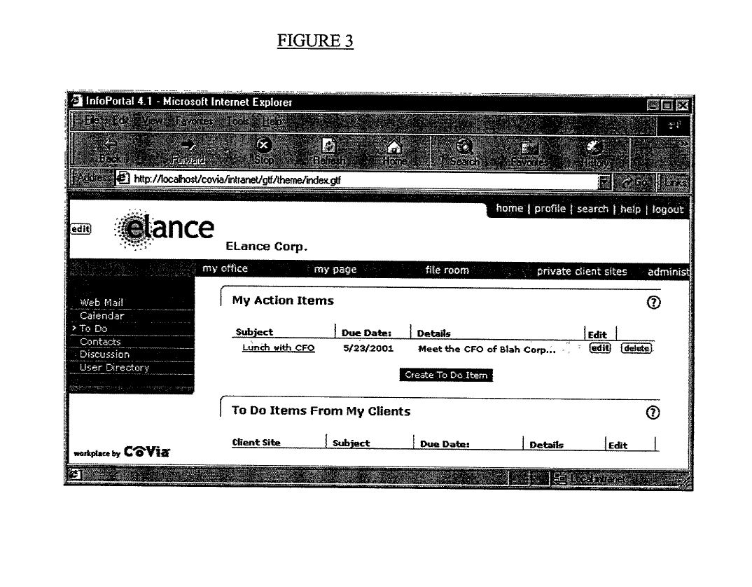

An example, described with the help of some sample screen shots (FIGS. 3 to 8), will help to illustrate the concept. With reference to FIG. 3, this screen shot illustrates (among other things) a list 302 of “to do” items headed by a header 304 “To Do Items From My Clients”. The corresponding web page source code 108 for generating the header 304 may be write(resources.get(“todo.textpageheaders.newtodo”)) and the corresponding HTML 104 that is generated by the dynamic page generator module 106 in a non-edit mode may be merely Create To Do Item

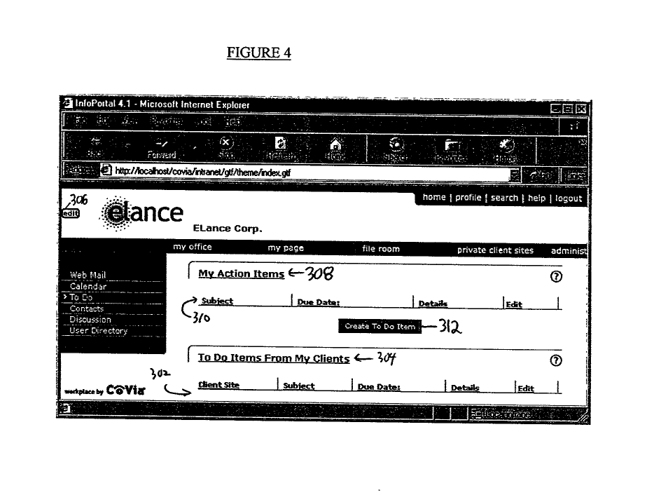

Referring still to FIG. 3, an “edit” button 306 is rendered. By clicking on the “edit” button 306, the “edit mode” is activated. This causes the screen illustrated in FIG. 4 to be rendered. The FIG. 4 screen is very similar to the FIG. 3 screen, except for the way certain items are rendered. For example, in the FIG. 4 screen, the “edit” button 306 has a thicker border than the “edit” button 306 shown in FIG. 3, to denote that the “edit mode” has been activated. In addition, the two headers (“My Action Items” 308 and “To Do Items From My Clients” 304) and the column titles 310 (“Client Site”, “Subject”, “Due Date:”, “Details”, “Edit”) are all underlined. Also, the “Create To Do Item” button 312 is surrounded by a border. This indicates that these portions of the display are associated with resources whose attributes are modifiable. (Other indications of modifiability are employed in accordance with other embodiments, such as links or a small ‘edit me’ button that appears in the vicinity of a rendered item associated with a resource whose attributes are modifiable.) As a particular example, the generated HTML 104 corresponding to the “View Your To Do Items” header may be

<A

HREF=”/composer/code/gtf/edit_resource_frameset.gtf?resource_id=todo@@text@ @pageheaders@@newt

odo&language_id=ENG&theme_id=style_c”

onMouseOver=”window.status=’This is the page header for the page that lets you create a new to do item

(a.k.a. action item.)’, return true;”onMouseOut=”window.status=”;”>Create To Do Item

</A>

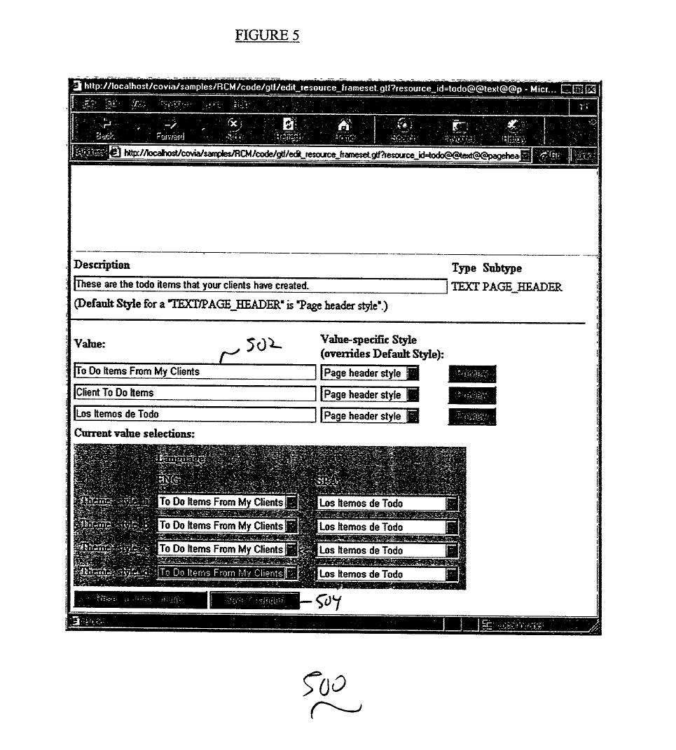

Thus, it can be seen that the resource is rendered by the browser as a link to a page for editing the resource. The link is used to inform the resource editor what resource (the header 304) is to be edited, as well as current choices for sub-styles associated with the resource (in this case, the sub-styles are language and theme identification). An example of the page for editing the resource is shown in FIG. 5, designated by reference numeral 500. Field 502 is a “value” field which it is desired to change. Because the page for editing the particular resource is provided automatically, user does not need to search for the resource definition. In addition to enabling activation of the resource editor for the header 304 by clicking on the header 304, processing of this HTML 104 by the browser 102 is such that when the user hovers the mouse over the header 304, a description will rendered in the status bar.

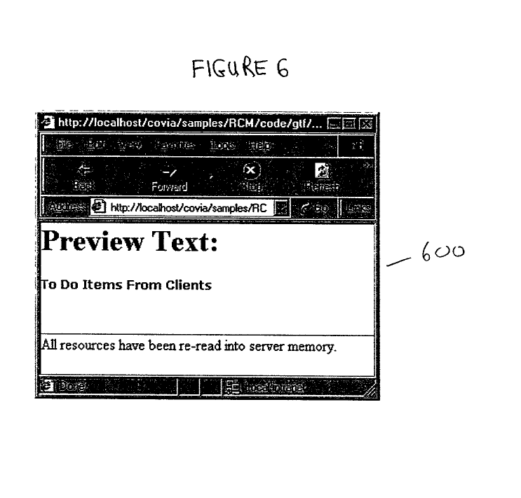

FIG. 6 illustrates a preview page 600 that is provided by the resource editor 118. The preview page 600 provides a preview of how the edited resource will appear after the value 502 “To Do Items From My Clients” is edited to “To Do Items From Clients”. Typically, the preview image will appear after the user activates the “save changes” button in the FIG. 5 resource editing page.

In one embodiment, resources that are image files are handled slightly differently. For example, in non-edit mode, the HTML for rendering an image might be:

<img src=”/covia/images/b_next.gif”>

whereas the corresponding HTML generated in edit mode might be:

<img src=””><a

href=”/composer/code/gtf/edit_resource_frameset.gtf?resource_id=todo@@images @@buttons@@next&lan

guage_id=ENG&theme_id=style_b”

onMouseOver=”window.status=Takes you to the next page’, return true;”

onMouseOut=”window.status=”<img src=”/covia/images/b_next.gtf”></A><img src=””>

In some embodiments, the “edit mode” is indicated and maintained on a per-user basis by the dynamic page generator module 106. For example, the dynamic page generator module 106 may access the “edit mode” indication using functions such as GetEditMode and SetEditMode. Depending on the “edit mode” indication for a particular user, it is determined (for example, at step 206 of the process illustrated in FIG. 2) whether to render the “edit mode” button and to provide the “edit mode” facility. The dynamic page generator module 106 may also maintain a privilege repository that indicates which users may employ the edit mode to access the resource editor 118 or, for that matter, access the resource editor 118 in any manner. In yet other embodiments, the “edit mode” is not user-specific at all and, rather, is shared among the users.

In accordance with the thus-described embodiment, the dynamic page generator module is configured (or configurable) to generate HTML such that resources are displayed in association with information that provides simplified navigation to a resource editor for editing that resource. In the described embodiments, the HTML is generated such that a user may activate the resource editor to edit the resource by activating the portion of the display in which the resource is rendered.

In accordance with other embodiments, the portion of the display to be activated to access the resource editor for a particular resource may be a portion of the display other than the portion of the display in which the resource is rendered. For example, the dynamic page generator module 106 may generate HTML such that a portion of the display in the immediate vicinity (or even in the not-so-immediate vicinity) is associated with the particular resource when the particular resource is rendered.

Having now described particular embodiments in accordance with the invention, it can be seen that the invention provides greatly simplified facilities for resource editing. While particular embodiments have been described and/or discussed, it should be understood that these embodiments have been presented by way of example only, and not limitation. The breadth and scope of the present invention should be defined in accordance with the claims and equivalents thereof.

1. A resource handler program executing on a server computer connected to a network, particularly suited for executing in conjunction with a dynamic page code generation program that generates display source code for execution on client computers connected to the network to render a document on the client computers in response to page requests, comprising:
a resource provider that, based on a request generated by the page code generation program for a resource, interacts with a resource repository to return a resource to be indicated in the display source code; and
a resource association provider that operates in conjunction with the resource provider to generate display source code to associate a portion of the display with a location in the resource repository associated with the resource such that, when the display source code is executed by particular ones of the client computers,
the resource is rendered on the display and a portion of the display is associated with the resource, and
when the portion of the display is indicated by the user, activation of a resource editor is requested to provide for changing the value of at least one attribute of the resource in the resource reposiitory.

2. The program of claim 1, wherein the resource association provider selectively causes the display source code to be generated to, when executed by the particular ones of the client computers, associate the portion of the display with the rendered resource based on a status of an edit mode.

3. The program of claim 1, wherein the resource association provider causes the display source code to be generated to, when executed by the particular ones of the client computers, associate the portion of the display with the resource by associating a link with the portion of the display on which the resource is rendered.

4. The program of claim 3, wherein the display source code is HTML and the link is an HTML link.

5. The program of claim 3, wherein the resource association provider causes the display source code to be generated to, when executed by the particular ones of the client computers, associate a link with the display of the value of the resource by including, with the display source code associated with rendering of the resource, display source code that includes a link to a resource editor that includes an indication of the location associated with the resource in the resource repository.

6. The program of claim 5, wherein the display source code is HTML and the link is an HTML link.

7. The program of claim 1, wherein the resource association provider causes the display source code to be generated to, when executed by the particular ones of the client computers, visually indicate with which resource the portion of the display is associated by associating the portion of the display in the immediate vicinity of the location at which the resource is displayed.

8. An article of manufacture having resource handler program code embodied thereon for execution by a server computer and particularly suited for executing in conjunction with a computer executing a dynamic page code generation program that generates display source code for execution on a client computer to render a document on the client computer, the resource handler program comprising:
attribute value provider code configured to cause the server computer to interact with a resource repository, based on a request generated by the computer executing the page code generation program for a resource, to return a value for an attribute of the resource to be indicated in the display source code; and
resource association provider code configured to cause the server computer to operate in conjunction with the server computer executing the resource value provider to generate display source code to associate a portion of the display with a location in the resource repository associated with the resource such that
when the display source code is executed on the client computer, the resource is rendered on the display and a portion of the display is associated with the resource, and
when the portion of the display is indicated by the user, activation of a resource editor is requested to provide for changing the value of at least one attribute of the resource.

9. The article of manufacture of claim 8, wherein the resource association provider code is configured to selectively cause the display source code to be generated to, when executed by the client computer, associate the portion of the display with the rendered resource based on a status of an edit mode.

10. The article of manufacture of claim 8, wherein the resource association provider code is configured to cause the display source code to be generated to, when executed by the client computer, associate the portion of the display with the resource by associating a link with the portion of the display on which the resource is rendered.

11. The article of manufacture of claim 10, wherein the display source code is HTML and the link is an HTML link.

12. The article of manufacture of claim 10, wherein the resource association provider code is configured to cause the display source code to be generated to, when executed by the client computer, associate a link with the display of the value of the resource by including, with the display source code associated with rendering of the resource, display source code that includes a link to a resource editor that includes an indication of the location associated with the resource in the resource repository.

13. The article of manufacture of claim 12, wherein the display source code is HTML and the link is an HTML link.

14. The article of manufacture of claim 8, wherein the resource association provider code is configured to cause the display source code to be generated to, when the display source code is executed by the client computer, cause the rendered display to visually indicate with which resource the portion of the display is associated by associating the portion of the display in the immediate vicinity of the location at which the resource is displayed.

15. A resource handler method, particularly suited for executing in conjunction with a dynamic page code generation program that generates display source code for execution on a client computer to render a document on the client computer, comprising:
a resource providing step of, based on a request generated by the page code generation program for a resource, interacting with a resource repository to return a resource to be indicated in the display source code; and
a resource association providing step operating in conjunction with the resource providing step to generate display source code to associate a portion of the display with a location in the resource repository associated with the resource such that
when the display source code is executed on the client computer, the resource is rendered on the display and a portion of the display is associated with the resource, and
when the portion of the display is indicated by the user, activation of a resource editor is requested to provide for changing the value of at least one attribute of the resource.

16. The method of claim 15, wherein the resource association providing step selectively causes the display source code to be generated to, when executed by the client computer, associate the portion of the display with the rendered resource based on a status of an edit mode.

17. The method of claim 15, wherein the resource association providing step causes the display source code to be generated to, when executed by the client computer, associate the portion of the display with the resource by associating a link with the portion of the display on which the resource is rendered.

18. The method of claim 17, wherein the display source code is HTML and the link is an HTML link.

19. The method of claim 15, wherein the resource association providing step causes the display generation code to be generated to, when executed by the client computer, associate a link with the display of the value of the resource by including, with the display code associated with rendering of the resource, display code that includes a link to a resource editor that includes an indication of the location associated with the resource in the resource repository.

20. The method of claim 19, wherein the display source code is HTML and the link is an HTML link.

21. The method of claim 15, wherein the resource association providing step causes the display generation code to be generated to, when executed by the client computer, visually indicate with which resource the portion of the display is associated by associating the portion of the display in the immediate vicinity of the location at which the resource is displayed.
